(19) United States
(12) Patent Application Publication
(10) Pub. No.: US 2009/0310895 A1
(43) Pub. Date: Dec. 17, 2009

(54) Bi-Stable Slider Mechanism, Associated Devices and Methods

(76) Inventors: Mikko Ukonaho, Nokia (FI); Esa-Sakari Määttä, Hampshire (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/227,512

(22) PCT Filed: May 16, 2007
(86) PCT No.: PCT/EP2007/004413

§ 371 Date: Mar. 20, 2009

(30) Foreign Application Priority Data
May 18, 2006 (GB) 0609825.5

(51) Int. Cl. F16C 29/02; B23P 11/00

(52) U.S. Cl. 384/29; 384/26; 29/428

(57) ABSTRACT

A slider mechanism, for an electronic device, the slider mechanism comprising first and second parts arranged to be linearly slideable with respect to one another along an axis of the slider mechanism, the first part comprising a shaft and a biasing mechanism, the shaft extending in the axial sliding direction of the slider mechanism and being rotatably mounted with respect to the biasing mechanism, the second part being arranged to be linearly axially slideable along the shaft along the axial sliding direction from a first position to a third position via an intermediate second position, axial sliding of the second part with respect to the first part and rotation of the shaft being interlinked, and wherein the shaft and the biasing mechanism are arranged to cause progressive loading of the biasing mechanism during relative axial sliding of the second part from the first position towards the intermediate second position, and to cause progressive unloading of the biasing mechanism during relative axial sliding of the second part from the intermediate second position towards the third position.

### TECHNICAL FIELD

The invention relates to slider mechanisms and electronic devices incorporating said slider mechanisms and associated methods. In particular, although not exclusively, the slider mechanisms are for use in electronic devices which may or may not be portable. Examples of user portable electronic devices are so-called mobile radio telephones. For convenience, discussion will be limited to mobile telephones.

For the avoidance of doubt, the present invention encompasses devices (and slider mechanisms/apparatus for such devices) which may or may not have radiotelephone functionality. The electronic devices may or may not provide one or more of audio/video functionality, music functionality (e.g. an MP3 player), digital image processing (including the capturing of a digital image), and/or controlling the operation of a remote apparatus (e.g. printer, monitor) which may be connected over a wire or over the air interface.

### BACKGROUND

In order to allow a more compact form factor, modern mobile communication devices such as mobile telephones commonly have mechanisms to enable conversion from a closed form to an open form. Different mechanisms are employed in, for example, clamshell and sliding form factor devices. In a clamshell form factor, a device is configured in two hinged halves, a hinge enabling the device to be opened into an expanded form. In a device of sliding form factor, two parts are linked by a slider mechanism to enable one part to slide over the other. In both types of devices, the action of opening may expose a keypad and/or a screen, thus serving the function of preventing inadvertent operation when closed as well as reducing the size of the overall device.

Typically, sliding form factor devices are bi-stable, i.e. have two stable positions in which a holding mechanism maintains the parts either closed or open in a relatively spaced relationship. The holding mechanism may, for example, be provided by resilient means such as a spring and/or a releasable latch. In many prior art sliding form factor devices, a spring provided in a bi-stable slider mechanism is located within a dividing plane of the slider mechanism. Such a mechanism is shown schematically in FIGS. 1a to 1c. A first part 11 and a second part 12 are configured to slide relative to one another, for example by means of slide rails 15a, 15b. A compressible spring 13 is provided in the dividing plane between the parts, the spring 13 connected to the first part 11 at a first connection point 14a and the second part 12 at a second connection point 14b. From an opened configuration corresponding to a first position as shown in FIG. 1a, sliding the first part 11 in the direction indicated by the arrow 16 initially compresses or loads the spring 13. As the first part is moved further in the same direction, an intermediate second position is passed, shown in FIG. 1b, where the spring 13 is maximally compressed or loaded. Beyond this intermediate second position the spring 13 uncompresses or is unloaded, thereby assisting further closing of the device. A third position, or closed configuration, is illustrated in FIG. 1c, where the spring 13 is again in an uncompressed or unloaded state, although a predetermined preload in the spring may be configured so that the spring 13 maintains the mechanism in either the first or third positions. The result is a bi-stable mechanism, wherein the spring 13 provides an assisting force for both opening and closing actions, as well as providing a force to maintain either position.

One disadvantage of the above mechanism is that, when the spring 13 is positioned within a dividing plane between the two parts, additional space larger than the size of the spring 13 itself is required within the dividing plane to accommodate lateral movement of the spring within the plane as the parts slide between the closed and open positions. This additional space therefore adds to the overall size of the device.

One or more embodiments of the present invention provide a compact bi-stable slider mechanism particularly for a user portable electronic device of sliding form factor.

One or more embodiments of the present invention overcome or mitigate at least some of the disadvantages indicated above.

### SUMMARY OF THE INVENTION

In a first aspect, the invention provides a slider mechanism, for an electronic device, the slider mechanism comprising first and second parts arranged to be linearly slideable with respect to one another along an axis of the slider mechanism,
the first part comprising a shaft and a biasing mechanism, the shaft extending in the axial sliding direction of the slider mechanism and being rotatably mounted with respect to the biasing mechanism, the second part being arranged to be linearly axially slideable along the shaft along the axial sliding direction from a first position to a third position via an intermediate second position, axial sliding of the second part with respect to the first part and rotation of the shaft being interlinked, and
wherein the shaft and the biasing mechanism are arranged to cause progressive loading of the biasing mechanism during relative axial sliding of the second part from the first position towards the intermediate second position, and to cause progressive unloading of the biasing mechanism during relative axial sliding of the second part from the intermediate second position towards the third position.

In a second aspect, the invention provides an electronic device comprising the slider mechanism of the first aspect of the invention.

In a third aspect, the invention provides a slider mechanism shaft for the slider mechanism of the first aspect of the invention, the shaft comprising a substantially cylindrical bar having a continuous helical thread on an outer surface, the helical thread comprising a left-handed threaded section and a right-handed threaded section.

In a fourth aspect, the invention provides the first part of the slider mechanism of the first aspect of the invention.

In a fifth aspect, the invention provides a method of assembling a slider mechanism, for an electronic device comprising:
providing a first part and mounting thereto a shaft and a biasing mechanism, the shaft being rotatably mounted with respect to the biasing mechanism;
mounting to the first part a second part, the second part being arranged to be linearly axially slideable along the shaft along an axis of the slider mechanism from a first position to a third position via an intermediate second position, axial sliding of the second part with respect to the first part being interlinked,
wherein the shaft and the biasing mechanism are arranged to cause progressive loading of the biasing mechanism during relative axial sliding of the second part from the first position towards the intermediate second position, and to cause progressive unloading of the biasing mechanism during relative axial sliding of the second part from the intermediate second position towards the third position.

Corresponding means for performing the function of the biasing mechanism of the above aspects of the invention are also intended to be within the scope of the invention.

The present invention includes one or more aspects, embodiments or features in isolation or in various combinations whether or not specifically stated (including claimed) in that combination or in isolation.

### BRIEF DESCRIPTION OF THE DRAWINGS

In order that the invention may more readily be understood, a description is now given, by way of example only, reference being made to the accompanying drawings, in which:

FIGS. 1a to 1c illustrate schematically a prior art bistable slider mechanism;

FIG. 2 illustrates an isometric view of a slider mechanism according to one embodiment of the present invention;

FIG. 3 illustrates a cutaway isometric view of the slider mechanism of FIG. 2;

FIG. 4 illustrates an isometric view of a slider mechanism of FIG. 2 with the slider mechanism in a first position;

FIG. 5 illustrates an isometric view of a slider mechanism of FIG. 2 at a transitional position;

FIG. 6 illustrates an isometric view of a slider mechanism of FIG. 2 at an intermediate second position;

FIG. 7 illustrates an isometric view of a slider mechanism of FIG. 2 at a further transitional position;

FIG. 8 illustrates an isometric view of a slider mechanism of FIG. 2 at a third position;

FIG. 9 illustrates a exemplary graphical representation of a relationship between force provided by a biasing mechanism and position of a sliding part for a slider mechanism according to an embodiment of the invention;

FIG. 10 illustrates an isometric view of an alternative biasing mechanism for a slider mechanism according to an embodiment of the invention;

FIG. 11 illustrates an isometric schematic view of a user portable electronic device comprising a slider mechanism according to an embodiment of the invention in a closed configuration;

FIG. 12 illustrates an isometric schematic view of a user portable electronic device comprising a slider mechanism according to an embodiment of the invention in an open configuration;

FIGS. 13a to 13e illustrate various alternative exemplary embodiments of a threaded shaft as part of the present invention;

FIGS. 14a to 14c illustrate alternative means for engagement between a shaft and a driving portion of the slider mechanism of the invention;

FIGS. 15a and 15b illustrate schematic cross-sectional views of parts of a slider mechanism of the invention;

FIGS. 16a to 16d illustrate various alternative forms of a transition region between a left handed and a right handed threaded portion of a shaft for a slider mechanism of the invention; and

FIGS. 17a to 17c illustrate plan schematic views of an alternative embodiment of a slider mechanism of the invention.

### DETAILED DESCRIPTION OF SPECIFIC EMBODIMENTS OF THE INVENTION

A slider mechanism 21 is shown in FIG. 2. The slider mechanism 21 comprises a first part 22 and a second part 23. In the embodiment shown, the first part is in the form of a frame 22, upon which is mounted a shaft 24, the shaft 24 being mounted at opposing ends by bearings 25a, 25b and extending along a lateral edge of the frame. A second, or sliding, part 23 is arranged to be linearly axially slideable along the shaft 24. In this embodiment the sliding part 23 is attached to the first part 22 by a driving portion 28. The sliding part 23 may additionally comprise a guiding portion 29. The guiding portion 29 is shown in FIG. 2 slideably mounted to a slide rail 26 provided on the frame 22, the slide rail 26 extending along an opposing lateral edge of the frame, the slide rail 26 being arranged to guide axial sliding of the sliding part 23 and thereby provide added stability for the sliding part 23.

The shaft 24 is provided with a continuous helical groove 30 on an outer surface. The helical groove 30 comprises a left-handed threaded section 31 and a right-handed threaded section 32. The driving portion 28 of the sliding part 23 is adapted to slide along the outer surface of the shaft 24 and engage with the helical groove 30 such that rotation of the shaft 24 about its longitudinal axis 44 and sliding of the sliding part 23 in a direction parallel to the longitudinal axis 44 of the shaft 24 are interlinked. The driving portion 28 may, for example, be provided with a lug or bearing on an internal surface that engages with and follows the path of the groove 30. The shaft 24 and the driving portion 28 of the sliding part 23 together effectively define a worm drive having two opposing driving directions corresponding to the two sections 31, 32 of the helical groove 30.

The shaft 24 may be of unitary construction. Alternatively, the shaft may be comprised of two or more pieces. For example, the shaft 24 may comprise two pieces, one piece having a left-handed thread and the other a right-handed thread. When joined together, the two pieces may then comprise the shaft as shown in FIG. 2.

The bearing 25a may further comprise a damping mechanism adapted to provide a damping resistance to rotation of the shaft 24 and thereby also to axial sliding motion of the sliding part 23.

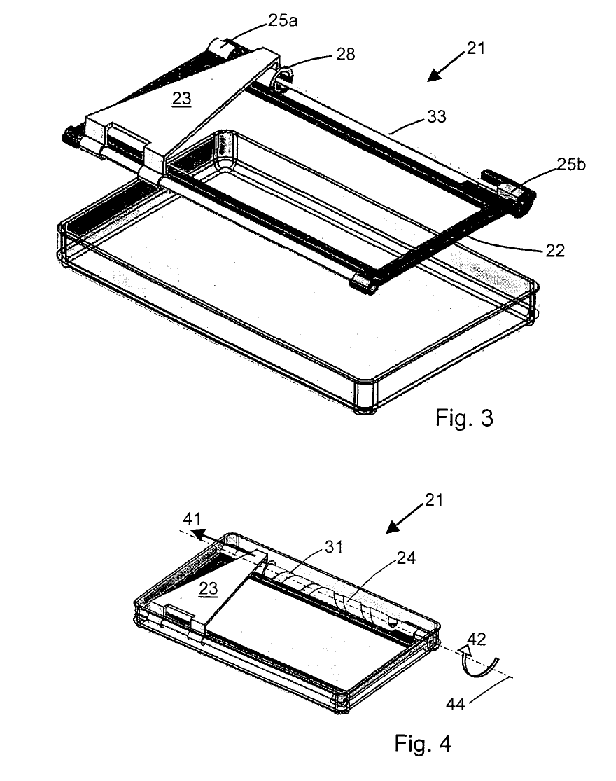

The slider mechanism 21 is further provided with a biasing mechanism, an exemplary embodiment of which is shown in FIG. 3. In FIG. 3, the slider mechanism of FIG. 2 is shown in cutaway form, where a biasing mechanism in the form of a torsion spring 33 is provided within a cavity in the shaft 24. In this case, the torsion spring 33 extends through the shaft 24 and is mechanically coupled to the bearings 25a, 25b at opposing ends of the shaft 24. The torsion spring 33 may be made from any suitable elastic or superelastic material. One particular exemplary material is nitinol, a superelastic metal alloy.

In FIGS. 2 and 3, the shaft 24 is connected such that rotation of the shaft 24 causes the torsion spring 33 to be loaded through rotation of the bearing 25a at one end of the shaft 24. The bearing 25b at the opposite end of the shaft 24 is fixed to the opposing end of the torsion spring 33 and prevents rotation of the end of the torsion spring attached thereto, while permitting rotation of the shaft 24.

In use, as the shaft 24 rotates in correspondence with axial movement of the sliding part 23, the torsion spring 33 is progressively loaded. The torsion spring 33 thereby acts to resist movement of the sliding part 23 through resistance to rotation of the shaft 24. Details of the operation of the slider mechanism are given below, in relation to FIGS. 4 to 8.

In order to provide a holding force on the sliding part 23 to maintain the slider mechanism in an open or a closed configuration, the torsion spring 33 may be provided with a preset bias. This preset bias may be set by applying a relative rotation between opposing ends of the torsion spring prior to attachment of the sliding part 23.

In FIG. 4, the slider mechanism 21 is shown with the sliding part 23 in a first position corresponding to a stable position, i.e. with no externally applied forces the parts will tend to remain in the configuration indicated. With a preset bias on the torsion spring 33, the sliding part 23 is held against a first end stop 43 (hidden in FIG. 4, but shown more clearly in FIG. 6). A preset bias provided on the torsion spring 33 applies a holding torque 42 in the direction indicated around a longitudinal axis 44 of the shaft 24. Through the action of the left-handed threaded section 31, the holding torque 42 is transformed to a holding force 41, which acts on the sliding part 23 in the direction indicated to hold the sliding part 23 against the first end stop 43.

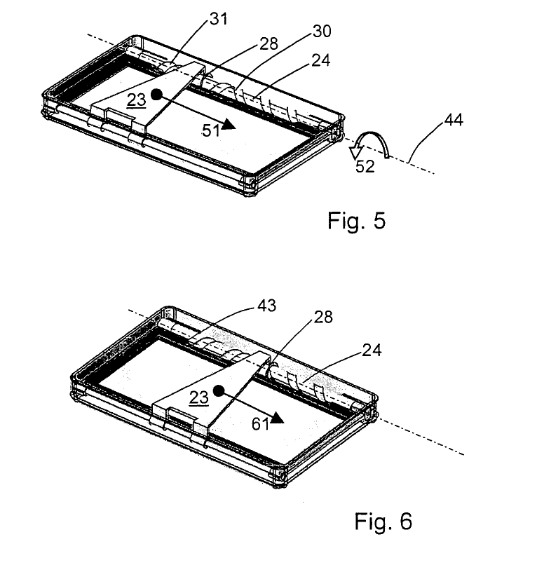

If a force is applied in a direction opposing and of a greater magnitude to the holding force 41, the sliding part 23 will begin to move axially along the first part 22 in a direction shown by arrow 51 in FIG. 5. This movement will cause rotation of the shaft 24 about the axis 44 and in the direction indicated by arrow 52, while the sliding part 23 is engaged with the left-handed threaded section 31 of the helical groove 30. The movement will also cause progressive loading of the torsion spring 33.

Rotation of the shaft 24 in the direction 52 will continue as the sliding part 23 continues to move in the direction 51, until the driving portion 28 of the sliding part 23 reaches the end of the left-handed threaded section 31 of the helical groove 30, as shown in FIG. 6. In this intermediate second position, with the sliding part still moving in the direction indicated by arrow 61, rotation of the shaft 24 momentarily stops.

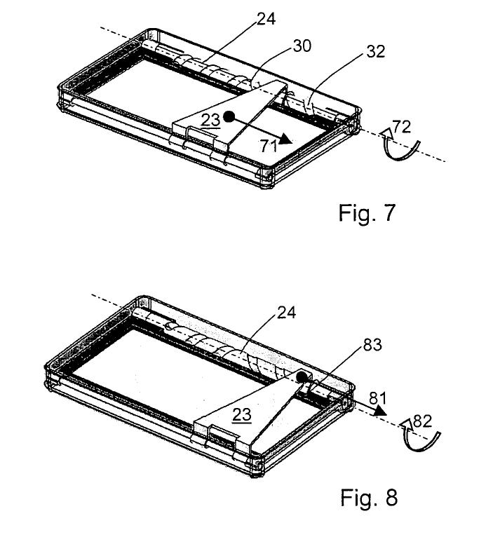

With further movement of the sliding part 23, as shown in FIG. 7, the direction of rotation of the shaft 24 reverses, and the shaft 24 now rotates in the direction shown by arrow 72, while the sliding part 23 is engaged with the right-handed threaded section 32 of the helical groove 30. In comparison to the position of FIG. 5, where the progressive loading of the torsion spring 33 through movement of the sliding part 23 in the direction 51 tends to resist movement of the sliding part 23, movement of the sliding part 23 in the same direction 71 while in the transitional position shown in FIG. 7 is assisted by the torsion spring 33 as the spring 33 is progressively unloaded.

Progressive unloading of the torsion spring 33 continues until the sliding part 23 reaches a second end stop 83, shown in FIG. 8. In this position, the preset bias on the torsion spring 33 provides a holding torque in the direction indicated by arrow 82, translated through the action of the right-handed threaded section 31 on the shaft 24 to a holding force indicated by arrow 81.

Consider a first position of the slider part 23 to be defined as being that shown in FIG. 4, an intermediate second position that shown in FIG. 6 and a third position that shown in FIG. 8. Given the above description in relation to FIGS. 4 to 8, the slider mechanism 21 is configured such that the biasing mechanism, which in one embodiment incorporates the torsion spring 33, provides a force that tends to urge the sliding part 23 towards the first position when the sliding part 23 is between the first position and the intermediate second position, and to urge the sliding part 23 towards the third position when the sliding part 23 is between the second and third positions. When the sliding part 23 is in either of the first or third positions, which may be as shown in FIGS. 5 and 7 respectively, the biasing mechanism, when provided with a preset bias, tends to maintain the sliding part 23 in that position.

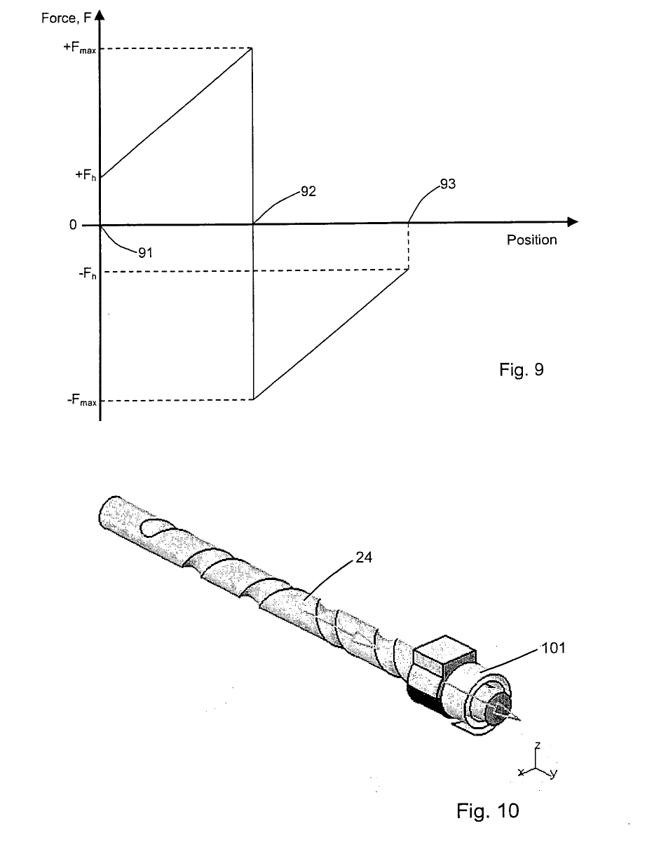

Shown in FIG. 9 is a graphical representation of the force F applied through the driving portion 28 of the sliding part 23 by the slider mechanism 21 of the invention, wherein the force F acting against the direction of movement 51, 61, 71 is shown as a function of position of the driving portion along the shaft 24. At position 91, corresponding to the first position in FIG. 4, the sliding part 23 is held with a force +Fₕ, being the holding force corresponding to a preset bias (which may be zero) provided on the torsion spring 33. As the sliding part 23 is moved towards the intermediate second position 92, corresponding to FIG. 6, the force F on the driving portion progressively rises towards a maximum value +Fₘₐₓ, as the torsion spring 33 is progressively loaded.

Around the intermediate second position 92, where the helical groove 30 changes from a left-handed thread 31 to a right-handed thread 32, the force F changes over from +Fₘₐₓ to −Fₘₐₓ, i.e. movement in the direction 51, 61, 71 is thereafter no longer resisted by the torsion spring 33 but is then assisted by the spring 33. As the sliding part 23 moves from the intermediate second position 92 towards the third position 93, the force F reduces in magnitude from −Fₘₐₓ to −Fₕ at the third position 93.

It is to be understood that the transition shown in FIG. 9 at the second position 92 from +Fₘₐₓ to −Fₘₐₓ may in practice be less abrupt than that shown in FIG. 9, due to considerations of the mechanical design of the slider mechanism. A less abrupt transformation may be achieved, for example, by design of a transition between the left- and right-handed helical grooves 31, 32, or by design of the internal lug or bearing within the driving portion 28 of the sliding part 23. In general, however, it should be clear that the intermediate second position 92 as shown in FIG. 9 is generally a position of instability, such that slight movements away from this position will tend to result in the sliding part 23 moving unaided by external forces towards either the first position 91 or the third position 93. Alternatively, the intermediate second position 92 may be a stable plateau, corresponding to a section of the helical thread running parallel to the longitudinal axis 44 of the shaft.

The slider mechanism may advantageously be configured such that sliding of the sliding part 23 along the shaft 24 is effected with little friction, such that when no external force is applied the sliding part will tend to return to one of the stable positions 91, 93. Various techniques may be employed to reduce friction in the slider mechanism 21 by appropriate choice of bearings, surface finishes and quality of components.

To limit the speed at which the sliding part 23 returns unaided to one of the two stable positions 91, 93, one or more of the bearings 25a, 25b may be provided with a damping mechanism. This damping mechanism may provide a resistive force to movement of the sliding part 23 that varies as a function of the speed of movement of the sliding part 23. For example, a damping mechanism may provide a force in a direction opposing the direction of movement 51, 61, 71 and of a magnitude proportional to the speed of movement of the sliding part. Other types of damping mechanisms may also be envisaged, which may for example act instead directly on the axial sliding movement of the sliding part 23.

Although a torsion spring 33 is described above in relation to the biasing mechanism for the slider mechanism 21, it is to be understood that other types of biasing mechanism may also be suitable for the invention. One possible alternative is shown in FIG. 10, where a shaft 24 is connected to a spiral spring 101. The spiral spring 101 provides the same function as the torsion spring 33, in that rotation of the shaft 24 loads the spring 101. The above description relating to the operation of the slider mechanism in FIGS. 4 to 8 may be applied equally to the slider mechanism incorporating a spiral spring 101.

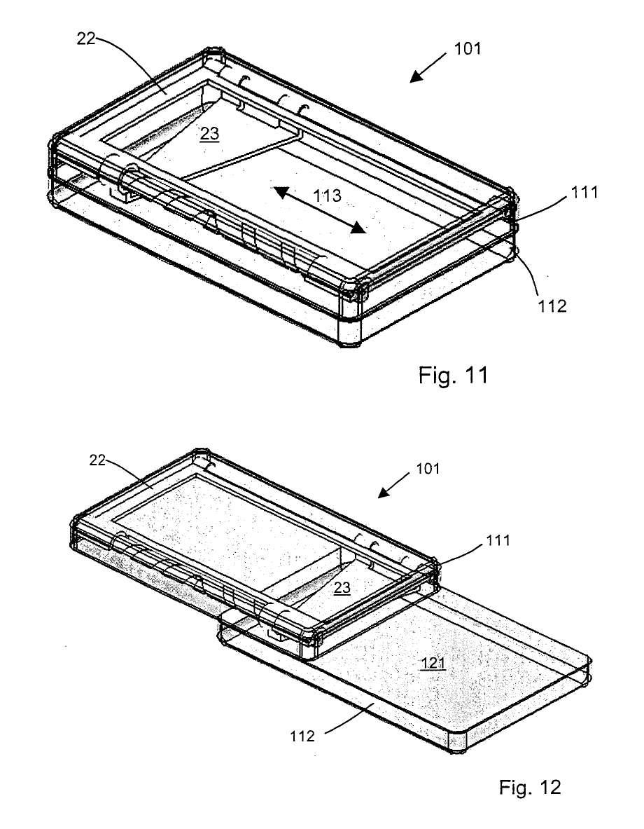

A schematic diagram of an exemplary embodiment of the slider mechanism as incorporated within a user portable radio telephone device 110 is illustrated in FIG. 11. The user portable radio telephone device 110 is comprised of two parts: an upper part 111 and a lower part 112 (although the terms ‘upper’ and ‘lower’ are to be understood as referring only in relation to the orientation of the device 110 as shown and not in any way limiting the scope of the invention). The upper part 111 is shown attached to the first part 22 of the slider mechanism 21, while the lower part 112 is connected to the second slider part 23 of the slider mechanism. The two parts 111, 112 of the user portable radio telephone device 110 are thereby able to slide relative to one another along the direction indicated by arrow 113.

Shown in FIG. 12 is the user portable radio telephone device 110 of FIG. 11 in an opened configuration, after the upper part 111 comprising the first part 22 of the slider mechanism 21 has moved relative to the lower part 112, attached to the slider part 23. In the open configuration, a face 121 of the lower part is exposed. The face 121 may comprise features such as a keypad or a screen.

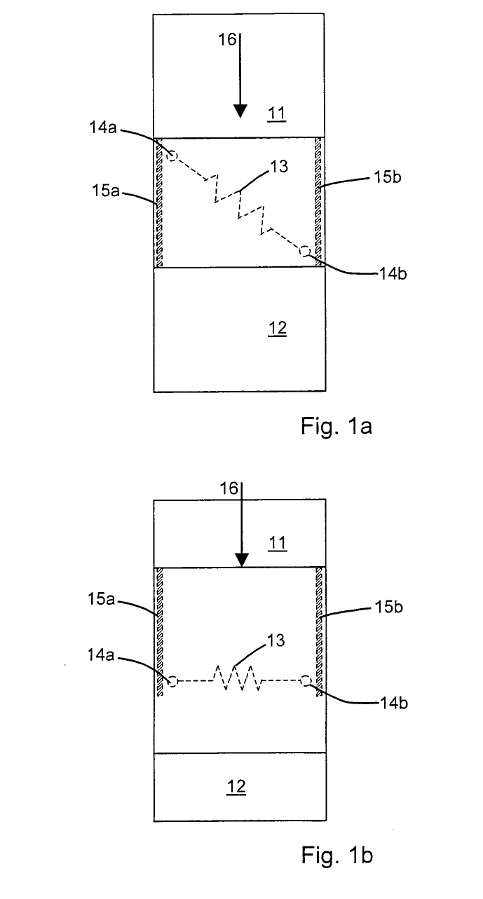

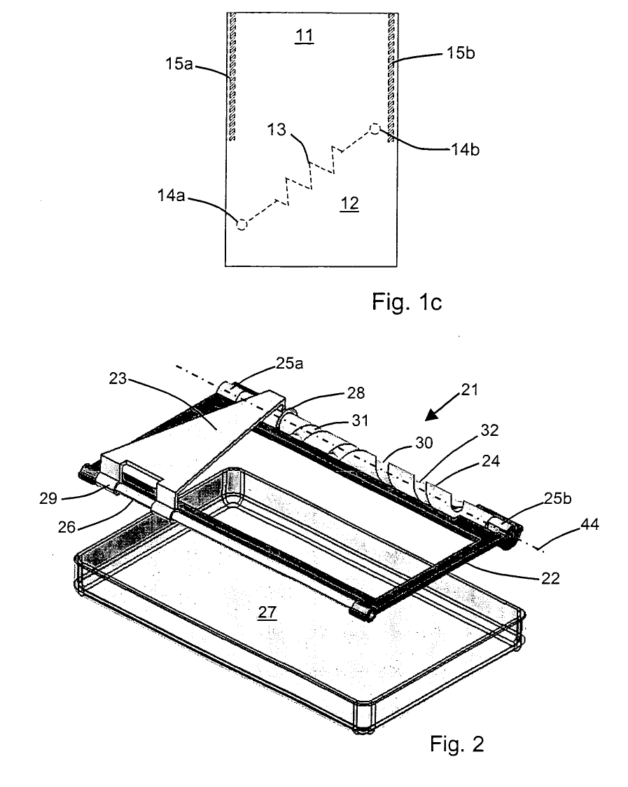

An advantage of the present invention is that a thinner sliding form factor device is possible when compared to the aforementioned prior art sliding form factor devices, since less space is required between the upper and lower parts 111, 112 which previously would be required for accommodation of the compressible spring (13, FIG. 1a).

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention. For example, the shaft 24 may be alternatively provided at positions within the frame 22 other than along a lateral edge, and the slide rail 26 may be provided at positions other than along an opposing lateral edge of the frame 22. Alternative positions for either the slide rail 26 or the shaft 24 may be midway between opposing lateral edges of the frame 22. Further, a slider mechanism 21 according to an embodiment of the invention may comprise more than one slide rail 26 and/or shaft 24.

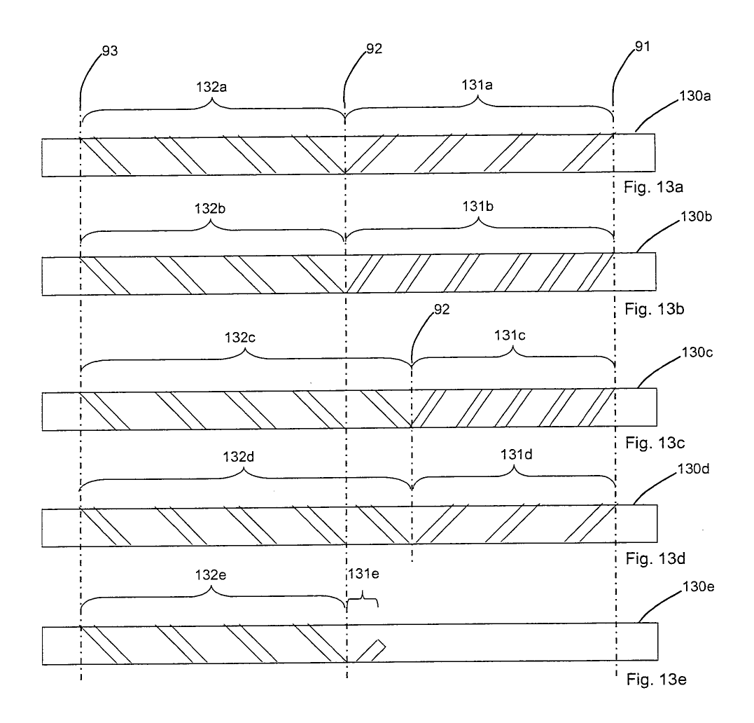

As will be understood, the left- and right-handed portions 31, 32 of the helical groove 30 in the shaft 24 of the slider mechanism 21 need not necessarily be either uniform or symmetrical along the length of the shaft 24. Shown in FIGS. 13a to 13e are various alternative arrangements for helical grooves, in which the pitch and/or length of each of the left- and right-handed portions 131a-e, 132a-e are varied.

FIG. 13a illustrates a shaft 130a according to the symmetrical arrangements of previous Figures, where a left-handed threaded portion 131a extends between a first position 91 and a second position 92, and a right-handed threaded portion 132a extends between the second position 92 and a third position 93.

FIG. 13b illustrates an alternative shaft 130b in which the left-handed threaded portion 131b has a reduced pitch, resulting in more turns of the shaft 130b being necessary to move a sliding part 23 from the first position 91 to the second position 92. To compensate for this, FIG. 13c illustrates a shaft 130c with an extended right-handed portion 132c and a shortened left-handed portion 131c, but with equal numbers of turns on each portion 131c, 132c.

FIG. 13d shows another alternative embodiment of a shaft 130d, where the pitch of the left- and right-handed threaded portions 131d, 132d are approximately equal, but the second position 92 is shifted away from a central intermediate position.

A yet further alternative shaft, 130e, shown in FIG. 13e, has a right-handed threaded portion 132e as for FIG. 13a, but with a shortened left-handed threaded portion 131e.

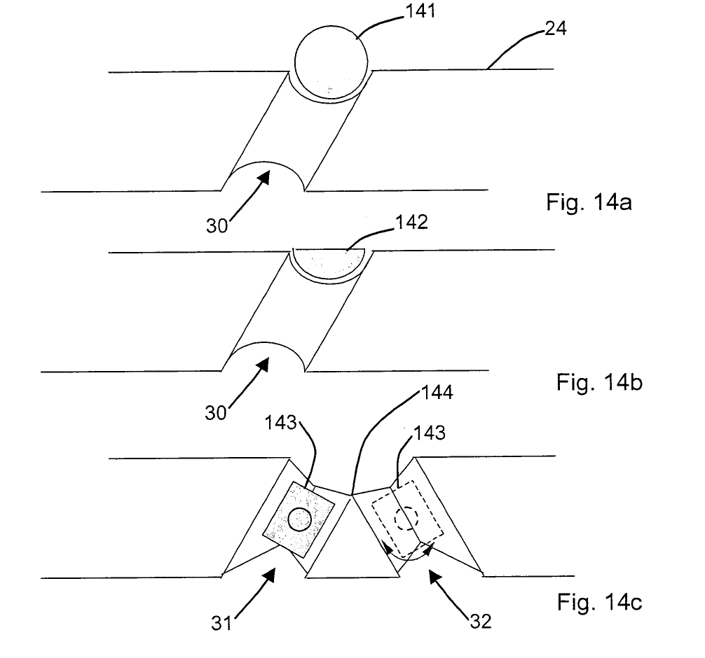

Shown in FIGS. 14a to 14c are various alternative exemplary embodiments of engagement mechanisms for the driving portion 28 (see FIG. 3) of the slider mechanism 21 of the invention. The driving portion 28 may be engaged with the groove 30 of the shaft 24 with a ball 141 adapted to follow the groove 30, as shown in FIG. 14a. Alternatively, the engagement mechanism, as shown in FIG. 14b, may be a hemisphere 142.

A further alternative mechanism may comprise a rotatable rib 143 adapted to follow the groove 30 of the shaft 24. The rib is adapted to adopt one of two positions shown in FIG. 14c, corresponding to the direction of the groove 31, 32. When passing over the intermediate position 144 joining the left-handed portion 31 to the right-handed portion 32, the rotatable rib changes orientation to follow the change in direction of the groove.

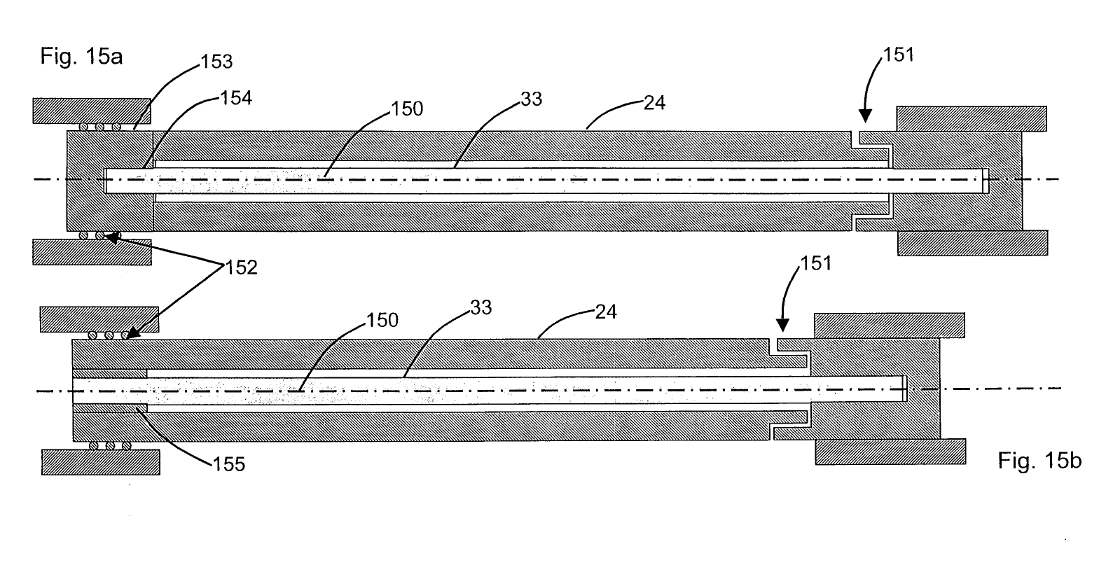

FIGS. 15a and 15b show two exemplary embodiments of a shaft 24 and a torsion spring 33 mounted on bearings 151, 152, comprising part of the slider mechanism 21 of the invention. The shaft 24, together with one end of the torsion spring 33, is arranged to rotate about a central axis 150 by means of bearings 151, 152. The torsion spring 33 and shaft 24 may be arranged such that the shaft is rotatable at the bearings 151, 152, while the torsion spring is fixed at or adjacent the bearing 151. Bearings 152 may be further provided with a damping mechanism such as a viscous lubricant, which may for example comprise a silicone-based grease.

The torsion spring 33 may be mechanically fixed to the shaft 24 by an end piece 153, as shown in FIG. 15a, the end piece 153 being provided with a recess 154 for receiving the torsion spring 33. Alternatively, the torsion spring 33 may, as shown in FIG. 15b, be affixed by means of a fixing collar 155, adapted to be fixed to an internal bore of the shaft 24.

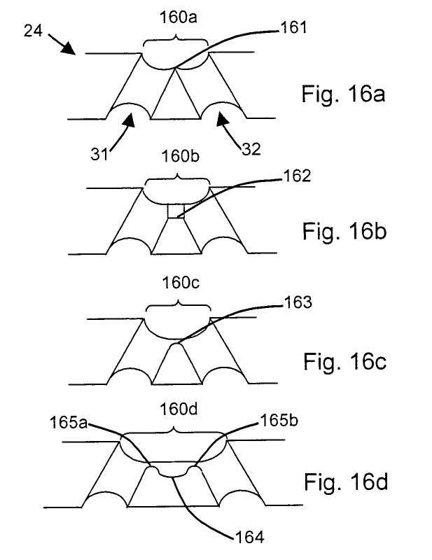

FIGS. 16a to 16d illustrate various alternative exemplary embodiments of transition regions 160a-d between the left- and right-handed threaded portions 31, 32 of the shaft 24. FIG. 16a shows a transition region 160a comprising a step transition 161, where the left-handed threaded portion 31 abruptly changes to the right-handed threaded portion 32. FIG. 16b shows a transition region 160b comprising a plateau 162, where the transition occurs in two steps, i.e. from the left-handed threaded portion 31 to the plateau 162, and from the plateau 162 to the right-handed threaded portion 32.

FIG. 16c shows a transition region 160c comprising a rounded or curved portion 163, which smoothes the transition between the left- and right-handed threaded portions 31, 32.

FIG. 16d shows a transition region 160d comprising a stable position 164 between two rounded or curved portions 165a, 165b. The transition region 160d thereby enables the sliding part 23 of the slider mechanism 21 to be held stably in the intermediate second position 92.

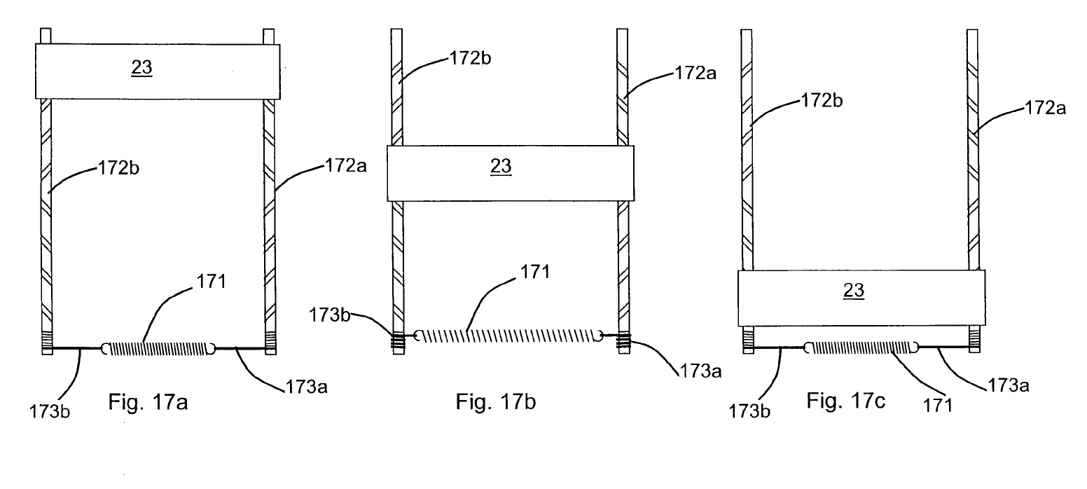

FIGS. 17a to 17c illustrate an alternative embodiment of a slider mechanism of the invention, in which two threaded shafts 172a, 172b are provided. The sliding part 23 is adapted to be slidably engaged with the shafts 172a, 172b. The first position 91, second position 92 and third position 93 of FIG. 9 correspond to the sliding part 23 in the positions shown in FIGS. 17a, 17b and 17c respectively.

A tension spring 171 is provided between the two shafts 172a, 172b, the spring 171 connected at opposing ends to each shaft by threads or wires 173a, 173b. As the shafts 172a, 172b rotate in correspondence with linear movement of the sliding part 23, the threads 173a, 173b are wrapped around the shafts 173a, 173b, which in turn extends the tension spring 171. As the sliding part 23 passes the intermediate position shown in FIG. 17b, where the tension spring 171 is maximally extended, the tension spring 171 provides a driving force to tend to urge the sliding part 23 towards the third position, shown in FIG. 17c. Thus the mechanism of FIGS. 17a-c operates in a similar way to that using the torsion spring 33 of FIG. 3 or the spiral spring 101 of FIG. 10.

It is to be understood that references herein to a spring or biasing mechanism are also intended to encompass any suitable equivalent resilient elastically deformable element that would perform the same or similar intended function, i.e. that of controllably storing and releasing elastic energy.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A slider mechanism, for an electronic device, the slider mechanism comprising first and second parts arranged to be linearly slideable with respect to one another along an axis of the slider mechanism,
the first part comprising a shaft and a biasing mechanism, the shaft extending in an axial sliding direction of the slider mechanism and being rotatably mounted with respect to the biasing mechanism, the second part being arranged to be linearly axially slideable along the shaft along the axial sliding direction from a first position to a third position via an intermediate second position, axial sliding of the second part with respect to the first part and rotation of the shaft being interlinked,
and wherein the shaft and the biasing mechanism are arranged to cause progressive loading of the biasing mechanism during relative axial sliding of the second part from the first position towards the intermediate second position, and to cause progressive unloading of the biasing mechanism during relative axial sliding of the second part from the intermediate second position towards the third position.

2. The slider mechanism of claim 1 wherein the biasing mechanism comprises a torsion spring.

3. The slider mechanism of claim 2 wherein the torsion spring is comprised at least partially within a cylindrical cavity provided within the shaft.

4. The slider mechanism of claim 1 wherein the biasing mechanism comprises a spiral spring.

5. The slider mechanism of claim 1 wherein the biasing mechanism is biased to provide a holding force to maintain the second part in position when located in either of the first or third positions.

6. The slider mechanism of claim 1 further comprising a damper mechanism adapted to provide a damping resistance to axial sliding of the second part.

7. The slider mechanism of claim 1, the first part further comprising a slide rail adapted to guide axial sliding of the second part, the second part being slidably connected to the slide rail.

8. The slider mechanism of claim 1 wherein the shaft comprises a substantially cylindrical bar having a continuous helical thread on an outer surface.

9. The slider mechanism of claim 8 wherein the helical thread comprises a left handed threaded section extending between the first position and the second position and a right handed threaded section extending between the second position and the third position.

10. The slider mechanism of claim 1 wherein the slider mechanism is adapted to cause rotation of the shaft in a first rotational direction during sliding of the second part from the first position towards the intermediate second position, and to cause rotation of the shaft in a second rotational direction during sliding of the second part from the intermediate second position towards the third position.

11. The slider mechanism of claim 9 wherein the shaft is a first shaft and the slider mechanism further comprises a second shaft, the second shaft extending in the axial sliding direction of the slider mechanism and being rotatably mounted with respect to the biasing mechanism, the second part being arranged to be linearly axially slideable along the second shaft along the axial sliding direction from the first position to the third position via the intermediate second position, axial sliding of the second part with respect to the first part and rotation of the second shaft being interlinked,
the second shaft and the biasing mechanism being arranged to cause progressive loading of the biasing mechanism during relative axial sliding of the second part from the first position towards the intermediate second position, and to cause progressive unloading of the biasing mechanism during relative axial sliding of the second part from the intermediate second position towards the third position,
the second shaft comprising a substantially cylindrical bar having a continuous helical thread on an outer surface, the helical thread comprising a right handed threaded section extending between the first position and the second position and a left handed threaded section extending between the second position and the third position.

12. The slider mechanism of claim 11 wherein the biasing mechanism comprises a tension spring extending between the first shaft and the second shaft, the tension spring being adapted to be loaded and unloaded in correspondence with rotation of the first and second shafts.

13. The slider mechanism of claim 12 wherein the tension spring is connected to the first shaft and the second shaft by threads at opposing ends of the tension spring, the threads being adapted to be wound around the first and second shafts during relative axial sliding of the second part from the first position towards the intermediate second position, and to be unwound from the first and second shafts during relative axial sliding of the second part from the intermediate second position towards the third position.

14. The slider mechanism of claim 9 wherein the shaft comprises two joined parts corresponding to the left-handed threaded section and the right handed threaded section.

15. The slider mechanism of claim 1, the first part comprising a frame, the shaft extending along a lateral edge of the frame, and a slide rail extending along an opposing lateral edge of the frame.

16. An electronic device comprising the slider mechanism of claim 1.

17. A slider mechanism shaft for the slider mechanism of claim 1, the shaft comprising a substantially cylindrical bar having a continuous helical thread on an outer surface, the helical thread comprising a left-handed threaded section and a right-handed threaded section.

18. The slider mechanism shaft of claim 17 wherein the shaft comprises two joined parts corresponding to the left-handed threaded section and the right handed threaded section.

19. The first part of the slider mechanism of claim 1.

20. A method of assembling a slider mechanism, for an electronic device comprising:
providing a first part and mounting thereto a shaft and a biasing mechanism, the shaft being rotatably mounted with respect to the biasing mechanism;
mounting to the first part a second part, the second part being arranged to be linearly axially slideable along the shaft along an axis of the slider mechanism from a first position to a third position via an intermediate second position, axial sliding of the second part with respect to the first part being interlinked,
wherein the shaft and the biasing mechanism are arranged to cause progressive loading of the biasing mechanism during relative axial sliding of the second part from the first position towards the intermediate second position, and to cause progressive unloading of the biasing mechanism during relative axial sliding of the second part from the intermediate second position towards the third position.

21. A slider mechanism, for an electronic device, the slider mechanism comprising first and second parts arranged to be linearly slideable with respect to one another along an axis of the slider mechanism,
the first part comprising a shaft and a means for biasing, the shaft extending in the axial sliding direction of the slider mechanism and being rotatably mounted with respect to the means for biasing, the second part being arranged to be linearly axially slideable along the shaft along the axial sliding direction from a first position to a third position via an intermediate second position, axial sliding of the second part with respect to the first part and rotation of the shaft being interlinked, and
wherein the shaft and the means for biasing are arranged to cause progressive loading of the means for biasing during relative axial sliding of the second part from the first position towards the intermediate second position, and to cause progressive unloading of the means for biasing during relative axial sliding of the second part from the intermediate second position towards the third position.

22. Apparatus for providing a sliding arrangement for an electronic device, the apparatus for providing a sliding arrangement comprising first means for sliding and second means for sliding arranged to be linearly slideable with respect to one another along an axis of the apparatus,
the first means for sliding comprising a means for transmitting motion and a means for biasing, the means for transmitting motion extending in the axial sliding direction of the apparatus and being rotatably mounted with respect to the means for biasing, the second means for sliding being arranged to be linearly axially slideable along the means for transmitting motion along the axial sliding direction from a first position to a third position via an intermediate second position, axial sliding of the second means for sliding with respect to the first means for sliding and rotation of the means for transmitting motion being interlinked, and wherein
the means for transmitting motion and the means for biasing are arranged to cause progressive loading of the means for biasing during relative axial sliding of the second means for sliding from the first position towards the intermediate second position, and to cause progressive unloading of the means for biasing during relative axial sliding of the second part from the intermediate second position towards the third position.

23. A method of assembling a slider mechanism, for an electronic device comprising:
providing a first part and mounting thereto a shaft and a means for biasing, the shaft being rotatably mounted with respect to the means for biasing;
mounting to the first part a second part, the second part being arranged to be linearly axially slideable along the shaft along an axis of the slider mechanism from a first position to a third position via an intermediate second position, axial sliding of the second part with respect to the first part being interlinked,
wherein the shaft and the means for biasing are arranged to cause progressive loading of the means for biasing during relative axial sliding of the second part from the first position towards the intermediate second position, and to cause progressive unloading of the means for biasing during relative axial sliding of the second part from the intermediate second position towards the third position.

24. A method of assembling a means for providing a sliding arrangement for an electronic device comprising:
providing a first means for sliding and mounting thereto a means for transmitting motion and a means for biasing, the means for transmitting motion being rotatably mounted with respect to the means for biasing;
mounting to the first means for sliding a second means for sliding, the second means for sliding being arranged to be linearly axially slideable along the means for transmitting motion along an axis of the means for providing a sliding arrangement for an electronic device from a first position to a third position via an intermediate second position, axial sliding of the second means for sliding with respect to the first means for sliding being interlinked,
wherein the means for transmitting motion and the means for biasing are arranged to cause progressive loading of the means for biasing during relative axial sliding of the second means for sliding from the first position towards the intermediate second position, and to cause progressive unloading of the means for biasing during relative axial sliding of the second means for sliding from the intermediate second position towards the third position.
